(19) United States
(12) Patent Application Publication
(10) Pub. No.: US 2007/0150685 A1
(43) Pub. Date: Jun. 28, 2007

(54) Computer architecture for providing physical separation of computing processes

(75) Inventor: Oleksiy Yu. Shevchenko, Ashburn, VA (US)

Correspondence Address: MCDERMOTT WILL & EMERY LLP, 600 13TH STREET, N.W., WASHINGTON, DC, 20005-3096, US

(73) Assignee: GBS LABORATORIES LLC

(21) Appl. No.: 11/318,584

(22) Filed: Dec. 28, 2005

(51) Int. Cl. G06F 13/00

(52) U.S. Cl. 711/167

(57) ABSTRACT

Novel circuitry and methodology for physically separating computing processes executing in a computer system that has a processing circuit, and first and second memory circuits for storing first and second data, respectively. The first and second memory circuits are accessed by the processing circuit for processing the first and second data using first and second processing information, respectively. The processing circuit erases the first processing information used by the processing circuit during operation with the first memory circuit before accessing the second memory circuit.

### FIELD OF THE INVENTION

The present disclosure relates to computer systems, and more particularly, to a computer architecture that provides physical separation of various computing processes.

### BACKGROUND ART

In the past several years, threats in the cyberspace have risen dramatically. With the ever-increasing popularity of the Internet, new challenges face corporate Information System Departments and individual users. Computing environments of corporate computer networks and individual computer devices are now opened to perpetrators using malicious software or malware to damage local data and systems, misuse the computer systems, or steal proprietary data or programs. The software industry responded with multiple products and technologies to address the challenges.

One way to compromise the security of a computer device is to cause the device to execute software that performs harmful actions on the computer device. For example, an ActiveX control, which is an outgrowth of two Microsoft technologies called OLE (Object Linking and Embedding) and COM (Component Object Model), is a powerful tool for sharing information among different applications. An ActiveX control can be automatically downloaded and executed by a Web browser. Because an ActiveX control is written in a native code it may have full access to the operating system and the process memory in which the ActiveX control is running. However, due to the full access to the operating system, the ActiveX control downloaded from an unknown source on the Internet creates serious security problems. A hostile ActiveX control may steal information from the host system's memory devices, implant a virus, or damage the host system.

There are various types of security measures that may be used to prevent a computer system from executing harmful software. System administrators may limit the software that a computer system can approach to only software from trusted developers or trusted sources. For example, the sandbox method places restrictions on a code from an unknown source. A trusted code is allowed to have full access to computer system's resources, while the code from an unknown source has only limited access. However, the trusted developer approach does not work when the network includes remote sources that are outside the control of the system administrator. Hence, all remote code is restricted to the same limited source of resources. In addition, software from an unknown source still has access to a local computer system or network and is able to perform harmful actions.

Another approach is to check all software executed by the computer device with a virus checker to detect computer viruses and worms. However, virus checkers search only for specific known types of threats and are not able to detect many methods of using software to tamper with computer's resources.

Further, firewalls may be utilized. A firewall is a program or hardware device that filters the information coming through the Internet connection into a private network or computer system. If an incoming packet of information is flagged by the filters, it is not allowed through. Firewalls use one or more of the following three methods to control traffic flowing in and out of the network.

A firewall may perform packet filtering to analyze incoming data against a set of filters. The firewall searches through each packet of information for an exact match of the text listed in the filter. Packets that make it through the filters are sent to the requesting system and all others are discarded.

Also, a firewall may carry out proxy service to run a server-based application acting on behalf of the client application. Accessing the Internet directly, the client application first submits a request to the proxy server which inspects the request for unsafe or unwanted traffic. Only after this inspection, the proxy server considers forwarding the request to a required destination.

Further, a firewall may perform stateful inspection, where it doesn't examine the contents of each packet but instead compares certain key parts of the packet to a database of trusted information. Information traveling from inside the firewall to the outside is monitored for specific defining characteristics, then incoming information is compared to these characteristics. The firewall looks not only at the IP packets but also inspect the data packet transport protocol header in an attempt to better understand the exact nature of the data exchange. If the comparison yields a reasonable match, the information is allowed through. Otherwise it is discarded.

However, the firewall technologies may miss vital information to correctly interpret the data packets because the underlying protocols are designed for effective data transfer and not for data monitoring and interception. For instance, monitoring based on an individual client application is not supported despite the fact that two identical data packets can have completely different meaning based on the underlying context. As a result, computer viruses or Trojan Horse applications can camouflage data transmission as legitimate traffic.

Further, a firewall is typically placed at the entry point of the protected network to regulate access to that network. However, it cannot protect against unauthorized access within the network by a network's user.

Also, advanced firewall strategies are based on a centralized filter mechanism, where most of the filtering operations are performed at the server. During operation of a typical centralized firewall, a single server might have to do the filtering work for hundreds of PC or workstations. This represents a major bottleneck to overall system performance. In the case of the statewide inspection, performance problems are aggravated because the firewall software needs to duplicate much of the protocol implementation of the client application as well as the transport protocol in order to understand the data flow. Providing a client-based filter does not adequately overcome the disadvantages of centralized filtering.

Accordingly, current methods have had only limited success in addressing cyberspace security problems. None of known computer protection methodologies is able to completely protect local computer's resources from perpetrator's actions. For example, no reliable protection is available against spyware or unknown threats.

Therefore, it would be desirable to create a computer system arrangement that enables a user to physically isolate various computing processes, for example, to prevent computing processes relating to less reliable or less trusted sources, such as processing Internet-related data, from compromising computing processes relating to more reliable or more trusted sources.

### SUMMARY OF THE DISCLOSURE

The present disclosure offers novel circuitry and methodology for physically separating computing processes executing in a computer system. In accordance with one aspect of the disclosure, a computer system comprises a processing circuit, and first and second memory circuits for storing first and second data, respectively. The first and second memory circuits are accessed by the processing circuit for processing the first and second data using first and second processing information, respectively. The processing circuit erases the first processing information used by the processing circuit during operation with the first memory circuit before accessing the second memory circuit. Also, a third memory circuit may be provided for storing data transferred from the first and second memory circuits. The processing circuit may comprise first and second processing units for operating with the first and second memory circuits, respectively.

The computer system may comprise registers for holding the first and second processing information during operations of the processing circuit with first and second memory circuits, respectively. These registers may include processing registers of the processing circuit and system registers arranged externally with respect to the processing circuit.

Further, the computer system may have a first storage circuit accessible by the processing circuit for writing the first processing information after suspending operation with the first memory circuit, and for retrieving the first processing information before resuming operation with the first memory circuit. Also, a second storage circuit accessible by the processing circuit may be provided for writing the second processing information after suspending operation with the second memory circuit, and for retrieving the second processing information before resuming operation with the second memory circuit.

A selector may control the processing circuit to operate with the first memory circuit and with the second memory circuit. The selector may be responsive to a first event to request the processing circuit to operate with the first memory circuit, and may be responsive to a second event to request the processing circuit to operate with the second memory circuit. In particular, the first event may corresponds to received data having a first attribute, and the second event may correspond to received data having a second attribute. For example, the first event may correspond to received data having a first Internet Protocol (IP) address, and the second event corresponds to received data having a second IP address. Hence, the first event may relate to data received from a first source, and the second event may relate to data received from a second source.

Also, the selector may control the processing circuit to operate with the first memory circuit during a first prescribed time interval, and to operate with the second memory circuit during a second prescribed time interval. The selector may allocate a first time period for operating the processing circuit with the first memory circuit, and to allocate a second time period for operating the processing circuit with the second memory circuit.

A switch may be provided for allocating a first prescribed set of peripheral devices to operation of the processing circuit with the first memory circuit, and for allocating a second prescribed set of peripheral devices to operation of the processing circuit with the second memory circuit. The first prescribed set may comprise at least one peripheral device from the second prescribed set.

The first and second memory circuits may be arranged in a memory device. An address divider may be provided for allocating a first address space of the memory device to the first memory circuit, and for allocating a second address space of the memory device to the second memory circuit.

In accordance with a method of the present disclosure, the following steps are carried out to operate a computer system:
controlling a processing circuit to operate with data from a first memory circuit using information in registers,
writing the information into a storage circuit after stopping operation with the first memory circuit,
erasing the information from the registers, and
controlling the processing circuit to operate with data from a second memory circuit.

Information from the storage circuit may be retrieved before resuming operation with the first memory circuit.

Additional advantages and aspects of the disclosure will become readily apparent to those skilled in the art from the following detailed description, wherein embodiments of the present disclosure are shown and described, simply by way of illustration of the best mode contemplated for practicing the present disclosure. As will be described, the disclosure is capable of other and different embodiments, and its several details are susceptible of modification in various obvious respects, all without departing from the spirit of the disclosure. Accordingly, the drawings and description are to be regarded as illustrative in nature, and not as limitative.

### BRIEF DESCRIPTION OF THE DRAWINGS

The following detailed description of the embodiments of the present disclosure can best be understood when read in conjunction with the following drawings, in which the features are not necessarily drawn to scale but rather are drawn as to best illustrate the pertinent features, wherein:

FIG. 1 is a block diagram schematically illustrating a concept of the present disclosure.

FIG. 2 is a block diagram illustrating an exemplary embodiment of the present disclosure in a PC environment.

### DETAILED DISCLOSURE OF THE EMBODIMENTS

The present disclosure is presented with an example of a personal computer (PC) environment. However, one skilled in the art would understand that the computer architecture disclosed herein may be implemented in any computer system or computer network.

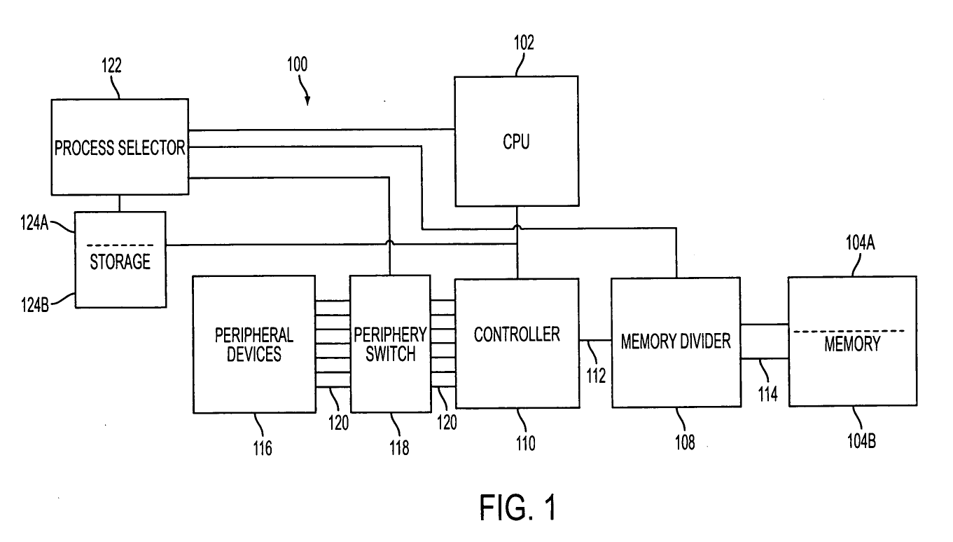

Referring to FIG. 1 that schematically illustrates a concept of the present disclosure, a computer system 100 may include one or more central processing units (CPU) 102 interacting with a memory 104 provided for storing information, and instructions to be executed by the CPU 102. For example, a random-access memory (RAM) may be used as the memory 104.

The memory 104 may store a number of items including, without limitations, programs to be executed by the computer system 100, data to be accessed by the system 100 and a runtime environment. The runtime environment typically is an operating system which manages computer resources required for the system 100 to operate. The runtime environment may also be a microkernel, a message passing system, a dynamic loadable linkable module, a browser application for the World Wide Web, a runtime interpreter environment, or any other system which manages computer resources. The CPU 102 may also interact with a read only memory (ROM) or other storage device for storing static information and instructions for the CPU 102, such as programs that boot the computer system 100 and perform diagnostics.

A memory divider 108 may be provided to divide the address space of the memory 104 into multiple memory sections. For example, the address space divider 108 may divide the address space of the memory 104 into at least two memory sections 104A and 104B. Also, an additional memory section may be provided, for example, for storing information transferred from the memory sections 104A and 104B. Alternatively, instead of the memory 104 having multiple sections, multiple memory devices accessible by the CPU 102 may be arranged.

Each section of the memory 104 may contain information including, without limitations, programs, data and a runtime environment, for supporting execution of a particular computing process or a particular group of processes. In particular, the memory section 104A may support a computing process or group of processes relating to data received from a data source or a group of data sources more reliable or more trusted that a data source or a group of data sources that originates data relating to a group of processes supported by the memory section 104B. A computing process may be a running instance of a program, including all variables and states. A program may have one or more processes corresponding to it.

For example, the memory section 104A may be designated as a “trusted” memory that contains information for supporting execution of processes relating to data received from a trusted data source or a trusted data network, whereas the memory section 104B may be designated as an “untrusted” memory that contains information for supporting execution of processes relating to data received from an untrusted data source or an untrusted data network. As disclosed in more detail below, the computer architecture of the present disclosure enables a user to physically separate less trusted processes run by the computer system 100 from more trusted processes run by this computer system. Such an architecture, among other purposes, may serve to prevent malware received from less trusted sources from contaminating data originated by a trusted data source and to prevent the malware from penetrating into computers of a trusted data network.

An access of the CPU 102 to the memory 104 via the address space divider 108 may be provided using a controller 110. A memory bus 112 may be arranged between the controller 110 and the divider 108. Multiple memory buses 114 may connect respective memory sections of the memory 104 to the divider 108.

Further, the controller 110 may provide access to multiple peripheral devices 116, which include, without limitation, hard disk drives, ports for connecting external devices, network interface cards (NICs), monitors, CD-ROM or DVD drives, keyboard and pointing devices such as an electronic mouse, trackball, light pen, thumb wheel, digitizing tablet, touch sensitive pad, etc. A peripheral switch 118 may be arranged to connect a prescribed set of the peripheral devices 116 to the controller 110 via appropriate buses 120. The switch 118 enables a user to select a particular set of the peripheral devices for a particular process or a particular group of processes run by the computer system 100. For example, one set of the peripheral devices 116 may be selected for a process or a group of processes supported by the trusted memory section 104A, whereas a different set of the peripheral devices 116 may be provided for a process or a group of processes supported by the untrusted memory section 104B. A user may include in the first set some of the devices from the second set.

Such an arrangement prevents contamination of “trusted” processes and data via a peripheral device contaminated by malware caused by data from untrusted sources. For example, processes supported by the trusted memory 104A and processes supported by the untrusted memory 104B may be supported by different NICs and/or different peripheral memory devices.

A process selector 122 may be provided to direct the CPU 102 to run one or more processes supported by the memory 104A or one or more processes supported by the memory 104B. The process selector 122 may be a controller that controls the CPU 102 to operate with the memory 104A or with the memory 104B. Also, the process selector 122 may control the peripheral switch 118 to select a desired set of the peripheral devices to support a process or a group of processes being currently run by the computer system 100.

The process selector 122 may be responsive to an interrupt caused by a particular event. In response to a particular event or group of events, e.g. events relating to reception of data from a trusted data source, the process selector 122 may request the CPU 102 to operate with the memory 104A, i.e. to run one or more processes associated with an access to the memory 104A. In response to another event or group of events, e.g. events relating to reception of data from an untrusted data source, the process selector 122 may direct the CPU 102 to operate with the memory 104B, i.e. to run one or more processes associated with an access to the memory 104B. For example, an event may be identified by a detected attribute of received data, such as an Internet Protocol (IP) address.

Alternatively, the process selector 122 may be programmed to direct the CPU 102 to operate with each memory section of the memory 104 within a prescribed time interval. Also, the process selector 122 may allocate particular time slots of variable or fixed durations for operations with particular memory sections of the memory 104.

Further, the computer system 100 may comprise a storage unit 124 for storing information relating to a process or a group of processes, which is not run by the system in a current time interval. The storage units 124 may be divided into multiple storage sections, the number of which may correspond to the number of sections in the memory 104. Alternatively, a number of separate storage devices may be provided for storing information on different processes or different groups of processes, which are not currently run by the system. Also, this information may be stored in separate sections of the memory 104.

For example, the storage unit 124 may include a section 124A for storing information on one or more processes associated with the memory section 104A, and a section 124B for storing information on one or more processes associated with the memory section 104B. As discussed in more detail below, the information stored by each section of the storage unit 124 includes content of registers provided in the CPU 102 and other registers in the system relating to running one or more processes associated with the respective section of the memory 104. Hence, each section of the storage unit 124 may store computer instructions, memory addresses and any kind of data, such as a bit sequence or individual characters, utilized when the CPU 102 operates with the respective memory section 104, i.e. when it runs the process or group of processes associated with the respective memory section. Alternatively, the CPU 102 may be arranged so as to include sections of the storage unit 124 as additional registers.

Also, the present disclosure describes only two memory sections 104, one skilled in the art would realize that the concept of the present disclosure is applicable to any number of the memory sections 104, i.e. the disclosed computer architecture may physically separate from each other any number of processes or process groups.

The computer system 100 may operate as follows. The process selector 122 requests the CPU 102 to operate with a prescribed memory section 104. For example, when the CPU 102 operates with the memory section 104A and receives a request from the process selector 122 to operate with the memory section 104B, the CPU 102 suspends processes associated with data of the memory section 104A. Thereafter, it writes into the storage section 124A all information associated with processing data of the memory section 104A. This information may include contents of registers provided in the CPU 102 and other registers in the system, i.e. computer instructions, memory addresses and any kind of data, such as a bit sequence or individual characters, utilized when the CPU 102 runs the process or group of processes associated with the memory section 104A. If the storage section 124A contains information written during a previous cycle of operation with the memory section 104A, the CPU 102 updates the content of the storage section 124 to represent the most recent information.

Then, the CPU 102 erases all information from its registers and other system registers involved in data processing, and loads these registers with data contained in the storage section 124B that may store information representing contents of the respective registers at a moment when the CPU 102 suspended the processes associated with the memory section 104B. Thereafter, the CPU 102 begins or resumes its operations with data of the memory section 104B.

When the process selector 122 instructs the CPU 102 to resume operations with data of the memory section 104A, the CPU 102 suspends a process or processes in connection with data of the memory section 104B, writes into the storage section 124B the information associated with processing of these data, and cleans the registers associated with the data processing from any information contained in these registers. Thereafter, the respective registers are loaded with the information from the storage section 124A, and the CPU 102 resumes operations with data of the memory section 102A.

Hence, after processing data of a particular memory section 104, the CPU 102 cleans all registers associated with the data processing before beginning operations with data of another memory section 104. As a result, the computer system 100 physically separate and isolate a computing process or processes associated with one memory section from a computing process or processes associated with another memory section.

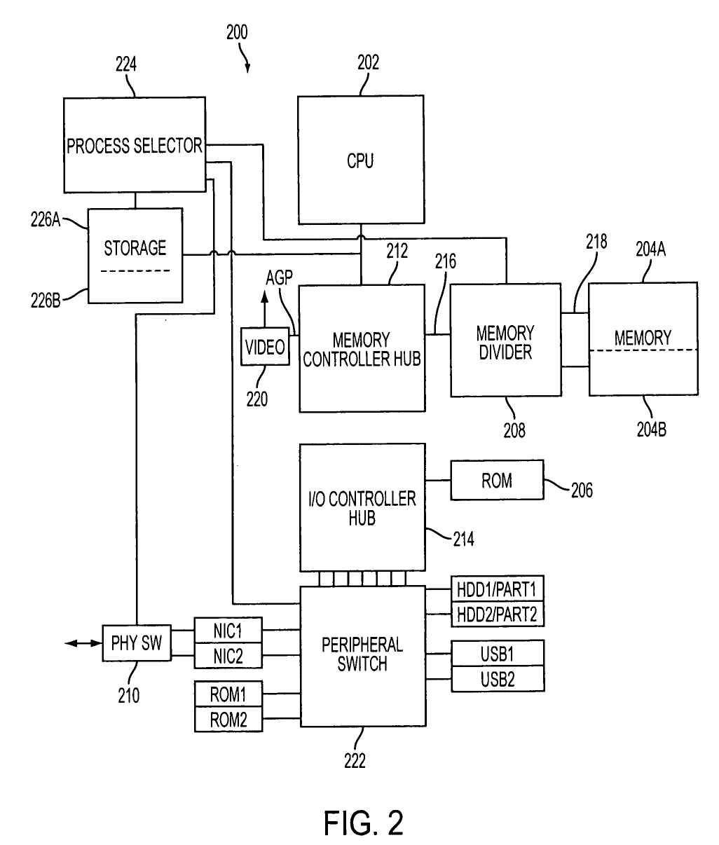

FIG. 2 is a block diagram illustrating an exemplary embodiment of the present disclosure in a personal computer (PC) system 200 having one or more CPUs 202 interacting with a RAM 204 and a ROM 206. A memory divider 208 divides the address space of the memory 204 into at least two memory sections 204A and 204B. Also, an additional memory section may be provided, for example, for storing information transferred from the memory sections 104A and 104B. Alternatively, instead of the memory 204 having multiple sections, multiple memory devices accessible by the CPU 202 may be arranged.

For example, the memory section 204A may contain operating system resources and other information allocated to computing processes relating to data transmitted or received via a physical layer data communication device (PHY) 210 to or from a trusted network, such as a secure intranet network belonging to an organization, and accessible only by the organization's members, employees, or others with authorization. The memory section 204A may contain operating system resources and other information allocated to computing processes relating to data transmitted or received via the PHY 210 to or from an untrusted network, such as an Internet network for providing data exchange with data sources or recipients outside the secure intranet network.

The PC 200 may comprise a memory controller hub 212 and an I/O controller hub 214. The memory controller hub 212 may provide a CPU interface to support one or more CPU 202. For example, instead of a single CPU 202, the PC 200 may contain a pair of CPUs each operating with a respective memory section 204.

Also, the memory controller hub 212 provides a memory interface for supporting an access to the memory 204 via the memory divider 208 and memory buses 216 and 218, and a video output interface, such as an accelerated graphics port (AGP) interface, to support a video card 220.

The I/O controller hub 214 may provide a direct connection from the memory 204 to peripheral devices via a peripheral switch 222 that selects a prescribed group of peripheral devices for connecting to a respective memory section of the memory 204. Also, the I/O controller hub 214 may provide an access to the ROM 206.

The peripheral devices may include, without limitation, network interface cards (NICs), modems, hard drives (HDs), Universal Serial Bus (USB) ports, memory devices, PCI add-in cards, etc. For example, FIG. 2 shows that the peripheral switch 222 provides connection to a pair of network interface cards NIC1 and NIC2, a pair of hard disk drives HDD1 and HDD2, and a pair of USB ports USB1 and USB2.

Also, a pair of read-only memories ROM1 and ROM2 may be connectable to the I/O controller hub 214 via the peripheral switch 222. ROM1 and ROM2 may store information and instructions associated with operations with the memory sections 204A and 204B respectively. For example, ROM1 may store a subsystem of a basic input/output system (BIOS) to support processes associated with the memory sections 204A, and ROM2 may store a subsystem of the BIOS to support processes associated with the memory sections 204B. When the computer system 200 is booted, the BIOS subsection from the ROM1 may be copied into the memory section 204A, whereas the BIOS subsection from the ROM2 may be copied into the memory section 204B.

NIC1, HDD1, USB1 and ROM1 may be selected by the peripheral switch 222 to support computing processes associated with the memory section 204A, and NIC2, HDD2, USB2 and ROM2 may be selected to support processes associated with the memory section 204B. Appropriate buses are provided between the peripheral switch 222 and the I/O controller hub 214 and between the peripheral switch 222 and the peripheral devices to support connection between a respective peripheral device and the memory 204.

The peripheral switch 222 supports physical separation of peripheral devices allocated to support computing processes being physically separated in the PC 200. As a result, processes executed in connection with a trusted network and respective data are prevented from being contaminated by processes and data associated with an untrusted network.

Alternatively, peripheral devices may be permanently connected to the I/O controller hub 214 via peripheral switch 222 or directly to the I/O controller hub 214 to support both processes associated with the memory section 204A and processes associated with the memory section 204B. In this case, internal registers or other data storages associated with the peripheral devices may be cleared when the computer system 200 switches between separated processes.

A process selector 224 controls the PC 200 to provide a selected computing process or group of computing processes. The process selector 224 may be responsive to an attribute detected in a data received by the PHY 210 to select computing processes associated with this attribute. Such an attribute, e.g. an IP address, may indicate whether the data are received from a trusted network or from an untrusted network.

For instance, if the data are received from the trusted network, the process selector 224 controls the CPU 202 and the memory divider 208 to enable execution of processes associated with the memory section 204A. Simultaneously, the process selector 224 controls the peripheral switch 222 to select a group of peripheral devices allocated for processes associated with the memory section 204A. If the data are received from the untrusted network, the process selector 224 controls the CPU 202 and the memory divider 208 to enable execution of processes associated with the memory section 204B. Simultaneously, the process selector 224 controls the peripheral switch 222 to select a group of peripheral devices allocated for processes associated with the memory section 204B.

Alternatively, the process selector 224 may be programmed to share total processing time of the PC 200 between separated computing processes. For example, the process selector 224 may allocate prescribed time slots for processes associated with the memory section 204A and other time slots for processes associated with the memory section 204B. Within time slots allocated for processes associated with the memory section 204A, the CPU 202, memory divider 208 and peripheral switch 222 are controlled to support these processes. Similarly, within time slots allocated for processes associated with the memory section 204B, the CPU 202, memory divider 208 and peripheral switch 222 are controlled to support the selected processes.

A storage device 226 is provided for storing processing information associated with processes, which are not currently executing. The storage device 226 may be divided correspondingly to the memory 204. For example, the storage device 226 may include a storage section 226A corresponding to processes associated with the memory section 204A and a storage section 226B corresponding to processes associated with the memory section 204B.

The storage section 226A may store processing information corresponding to processes associated with the memory section 204A when these processes are suspended due to execution of processes associated with the memory section 204B. Similarly, the storage section 226B may store processing information corresponding to processes associated with the memory section 204B when these processes are suspended due to execution of processes associated with the memory section 204A. The process selector 224 may control the storage device 226 to enable operations with respective storage sections. Alternatively, the CPU 202 may include sections of the storage device 226 as additional registers that may be arranged in separate register sections.

As discussed above, the CPU 202 cleans registers involved in processing data associated with the memory section 204A before accessing the memory section 204B. Similarly, it erases information from registers involved in processing data associated with the memory section 204A before accessing the memory section 204B. The erased information is stored in the respective storage section 226A or 226B until the CPU 202 resumes execution of the corresponding processes.

As a result, processes and data associated with the memory section 204A are physically separated and isolated from processes and data associated with the memory section 204B.

The foregoing description illustrates and describes aspects of the present invention. Additionally, the disclosure shows and describes only preferred embodiments, but as aforementioned, it is to be understood that the invention is capable of use in various other combinations, modifications, and environments and is capable of changes or modifications within the scope of the inventive concept as expressed herein, commensurate with the above teachings, and/or the skill or knowledge of the relevant art.

For example, the present disclosure describes separation of processes and data associated with a trusted data network from processes and data associated with an untrusted data network. However, one skilled in the art would realize that the present invention enables a user to separate any selected process or a group of processes and the respective data from any other processes and data. For example, processes executing in connection with data from a local data source, such as a hard drive or a USB drive, may be separated from other processes executing in a computer system.

Further, the present disclosure describes processes associated with two memory sections. However, one skilled in the art would realize that the computer architecture of the present invention may include any number of memory sections or separate memories to support separated execution of any number of processes in a computer system.

The embodiments described hereinabove are further intended to explain best modes known of practicing the invention and to enable others skilled in the art to utilize the invention in such or other embodiments and with the various modifications required by the particular applications or uses of the invention.

Accordingly, the description is not intended to limit the invention to the form disclosed herein. Also, it is intended that the appended claims be construed to include alternative embodiments.

What is claimed is:

1. A computer system comprising:
a processing circuit, and
first and second memory circuits for storing first and second data, respectively; said first and second memory circuits being accessed by the processing circuit for processing the first and second data using first and second processing information, respectively,
said processing circuit being operative for erasing the first processing information used by the processing circuit during operation with the first memory circuit before accessing the second memory circuit.

2. The system of claim 1, further comprising registers for holding the first and second processing information during operations of the processing circuit with first and second memory circuits, respectively.

3. The system of claim 2, wherein the registers include processing registers of the processing circuit and system registers arranged externally with respect to the processing circuit.

4. The system of claim 1, further comprising a first storage circuit accessible by the processing circuit for writing the first processing information after suspending operation with the first memory circuit, and for retrieving the first processing information before resuming operation with the first memory circuit.

5. The system of claim 4, further comprising a second storage circuit accessible by the processing circuit for writing the second processing information after suspending operation with the second memory circuit, and for retrieving the second processing information before resuming operation with the second memory circuit.

6. The system of claim 5, wherein the processing circuit is arranged so as to include the first storage circuit and the second storage section as separate register sections.

7. The system of claim 1, further comprising a selector for controlling the processing circuit to operate with the first memory circuit and with the second memory circuit.

8. The system of claim 7, wherein the selector is responsive to a first event to request the processing circuit to operate with the first memory circuit, and is responsive to a second event to request the processing circuit to operate with the second memory circuit.

9. The system of claim 8, wherein the first event corresponds to received data having a first attribute, and the second event corresponds to received data having a second attribute.

10. The system of claim 8, wherein the first event corresponds to received data having a first Internet protocol address, and the second event corresponds to received data having a second Internet protocol address.

11. The system of claim 8, wherein the first event corresponds to data received from a first source, and the second event corresponds to data received from a second source.

12. The system of claim 7, wherein the selector is operative for controlling the processing circuit to operate with the first memory circuit during a first prescribed time interval, and for controlling the processing circuit to operate with the second memory circuit during a second prescribed time interval.

13. The system of claim 7, wherein the selector is operative to allocate a first time period for operating the processing circuit with the first memory circuit, and to allocate a second time period for operating the processing circuit with the second memory circuit.

14. The system of claim 1, further comprising a switch for allocating a first prescribed set of peripheral devices to operation of the processing circuit with the first memory circuit, and for allocating a second prescribed set of peripheral devices to operation of the processing circuit with the second memory circuit.

15. The system of claim 14, wherein the first prescribed set comprises at least one peripheral device from the second prescribed set.

16. The system of claim 1, further comprising a third memory circuit for storing data transferred from the first and second memory circuits.

17. The system of claim 1, further comprising a memory device having the first and second memory circuits.

18. The system of claim 17, further comprising an address divider for allocating a first address space of the memory device to the first memory circuit, and for allocating a second address space of the memory device to the second memory circuit.

19. The system of claim 1, further comprising first and second basic input/output system (BIOS) devices for respectively storing first and second subsections of a BIOS associated with the first and second memory circuits, respectively.

20. The system of claim 19, wherein the first subsection of the BIOS is copied into the first memory circuit and the second subsection is copied into the second memory section when the computer system is booted.

21. The system of claim 1, wherein the processing circuit comprises first and second processing units for operating with the first and second memory circuits, respectively.

22. A method of operating a computer system, comprising the steps of:
controlling a processing circuit to operate with data from a first memory circuit using information in registers,
writing the information into a storage circuit after stopping operation with the first memory circuit,
erasing the information from the registers, and
controlling the processing circuit to operate with data from a second memory circuit.

23. The method of claim 22, further comprising the step of retrieving information from the storage circuit before resuming operation with the first memory circuit.
